(19) United States
(12) Patent Application Publication
(10) Pub. No.: US 2013/0319837 A1
(43) Pub. Date: Dec. 5, 2013

(54) PRESS KEY

(71) Applicant: Qing ZHANG, Changshu (CN)

(72) Inventor: Qing ZHANG, Changshu (CN)

(21) Appl. No.: 13/484,812

(22) Filed: May 31, 2012

(51) Int. Cl. H01H 13/52

(52) U.S. Cl. 200/512

(57) ABSTRACT

A press key includes: a base plate; a bordering plate disposed above and coupled to the base plate, and formed with a through hole; a keycap movable between a raised position and a pressed position, the keycap being configured to pass through the through hole to be partially exposed from the bordering plate when the keycap is at the raised position; a circuit board disposed between the keycap and the base plate; an elastic restoring unit disposed between the keycap and the circuit board; a limiting mechanism disposed between the bordering plate and the keycap; and a guiding mechanism disposed between the keycap and the base plate to guide the movement of the keycap.

### BACKGROUND OF THE INVENTION

1. Field of the Invention

This invention relates to a press key, more particularly to a press key for a thin type keyboard.

2. Description of the Related Art

A conventional press key device usually utilizes a scissors-type supporting structure, such as a press key device with a supporting structure disclosed in Taiwanese Utility Model No. M375243. The scissors-type supporting structure disposed under the keycap can disperse the force applied to the keycap. Accordingly, regardless of whether the user presses the central part, lateral side or corner of the keycap, the keycap can be guided and supported by the scissors-type supporting structure to move up and down smoothly, thereby enhancing moving stability of the keycap.

However, the scissors-type supporting structure is constituted by a large number of components, which have relatively complex structures, and which should be assembled using joint elements. Therefore, the conventional press key device with the scissors-type supporting structure has a bulky volume which is disadvantageous to the miniaturization of the press key device.

### SUMMARY OF THE INVENTION

Therefore, an object of the present invention is to provide a press key with a simple structure capable of achieving the effect of miniaturization.

Accordingly, a press key of this invention comprises:

a base plate;

a bordering plate disposed above and coupled to the base plate, and formed with a through hole, the base plate and the bordering plate defining an accommodating space therebetween;

a keycap movable between a raised position and a pressed position, the keycap being configured to pass through the through hole to be partially exposed from the bordering plate when the keycap is at the raised position;

a circuit board disposed between the keycap and the base plate;

an elastic restoring unit disposed between the keycap and the circuit board, and capable of providing a restoring force to move the keycap to the raised position;

a limiting mechanism disposed between the bordering plate and the keycap to prevent an upward movement of the keycap away from the raised position; and

a guiding mechanism disposed between the keycap and the base plate to guide the movement of the keycap.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of the first preferred embodiment of a press key according to this invention;

FIG. 2 is a top view of the press key of FIG. 1;

FIG. 3 is a cross-sectional view taken along line III-III of FIG. 2;

FIG. 4 is an exploded perspective view of the second preferred embodiment of a press key according to this invention;

FIG. 5 is an exploded perspective view of the third preferred embodiment of a press key according to this invention;

FIG. 6 is an exploded perspective view of the fourth preferred embodiment of a press key according to this invention;

FIG. 7 is an exploded perspective view of the fifth preferred embodiment of a press key according to this invention; and

FIG. 8 is an exploded perspective view of the sixth preferred embodiment of a press key according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

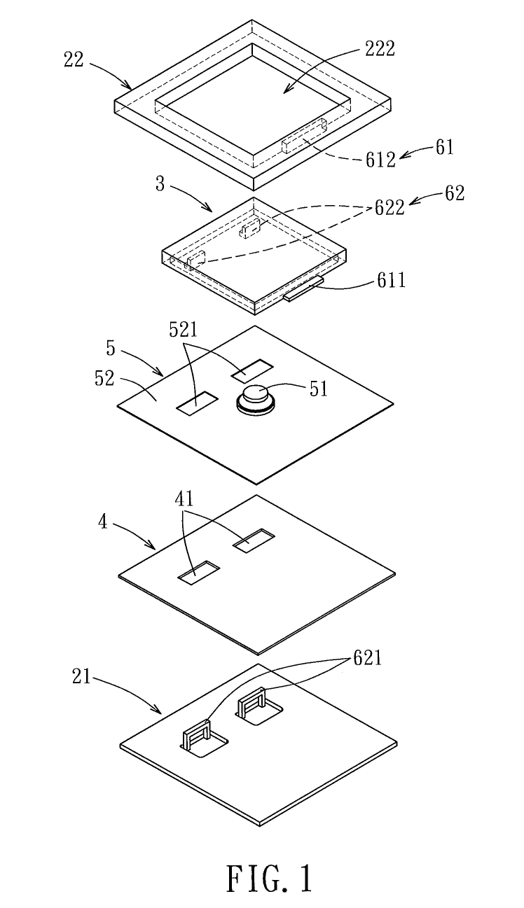

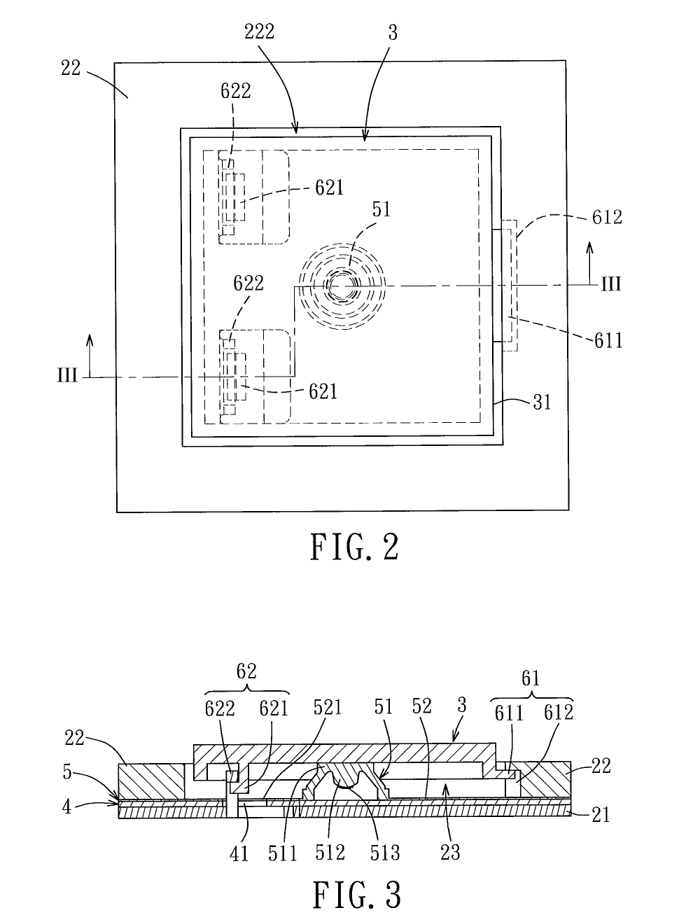

Referring to FIGS. 1 to 3, the first embodiment of a press key according to this invention is shown to comprise: a base plate 21, a bordering plate 22, a keycap 3, a circuit board 4, an elastic restoring unit 5, a limiting mechanism 61, and a guiding mechanism 62.

The bordering plate 22 is disposed above and coupled to the base plate 21, and the base plate 21 and the bordering plate 22 define an accommodating space 23 therebetween. The bordering plate 22 is formed with a through hole 222 in spatial communication with the accommodating space 23. The keycap 3 is movable between a raised position and a pressed position. The keycap 3 is configured to pass through the through hole 222 to be partially exposed from the bordering plate 22 when the keycap 3 is at the raised position.

The circuit board 4 is disposed between the keycap 3 and the base plate 21. The elastic restoring unit 5 is disposed between the keycap 3 and the circuit board 4, and includes an elastic member 51 and an elastic sheet 52. As best shown in FIG. 3, the elastic member 51 is formed in one-piece with the elastic sheet 52, and includes a hollow main body 511, a contact 512, and a conductive layer 513. The hollow main body 511 is formed in a truncated conic shape having a top end abutting against a lower surface of the keycap 3. The contact 512 protrudes downwardly from an inner face of the top end of the hollow main body 511 toward the circuit board 4. The conductive layer 513 covers a bottom end of the contact 512. The elastic member 51 provides a restoring force to move the keycap 3 to the raised position (i.e., the keycap 3 is normally disposed away from the circuit board 4). When the keycap 3 is pressed to deform the elastic member 51, the conductive layer 513 is moved to electrically contact the circuit board 4.

In this embodiment, the circuit board 4 is a thin-film circuit board of a single layer. In other embodiments, the conductive layer 513 may be dispensed with. In such case, the circuit board 4 may be a thin-film circuit board including an upper layer, a lower layer and a middle layer disposed between the upper and lower layers. The middle layer is formed with a through hole in a position corresponding to the contact 512 of the elastic member 51, and the upper and lower layers are respectively formed with conductors that face each other in the position corresponding to the contact 512. Accordingly, when the contact 512 of the elastic member 51 is moved to contact the upper layer, the conductor of the upper layer is brought into contact with that of the lower layer, thereby generating an electrical signal. Alternatively, the elastic restoring unit 5 may be an arc-shaped metal dome, which has a central portion able to elastically deform to contact the circuit board 4, and which can perform the function of the elastic member 51. In view of the foregoing description, the elastic restoring unit 5 and the circuit board 4 may have various modifications, and thus should not be limited to the configuration of this embodiment.

The limiting mechanism 61 is disposed between the keycap 3 and the bordering plate 22 to prevent an upward movement of the keycap 3 away from the raised position. The limiting mechanism 61 includes a protrusion 611 and a recess 612. The protrusion 611 is disposed on one of the keycap 3 and the bordering plate 22, and the recess 612 is formed in the other one of the keycap 3 and the bordering plate 22. In this embodiment, the protrusion 611 extends from a lateral side of the keycap 3, and the recess 612 is indented from a lower face of the bordering plate 22 proximate to a wall defining the through hole 22. The protrusion 611 is disposed in the recess 612 to abut against an inner wall of the recess 612 when the keycap 3 is at the raised position.

The guiding mechanism 62 is disposed between the keycap 3 and the base plate 21 to guide the movement of the keycap 3. The guiding mechanism 62 includes at least one guide rail 621 and at least one guide hook 622 that is in sliding engagement with the guide rail 621. The guide rail 621 is disposed on one of the lower surface of the keycap 3 and an upper surface of the base plate 21, and the guide hook 622 is disposed on the other one of the lower surface of the keycap 3 and the upper surface of the base plate 21.

In this embodiment, the guiding mechanism 62 has two guide rails 621 and two guide hooks 622. The circuit board 4 is formed with two through holes 41 in positions corresponding to the guide rails 621. The elastic sheet 52 is formed with two through holes 521 in positions corresponding to the guide rails 621. Each of the guide rails 621 extends upwardly from the upper surface of the base plate 21 to pass through a respective one of the through holes 41 and a respective one of the through holes 521, and is formed with a slot. Each of the guide hooks 622 extends downwardly from the lower surface of the keycap 3, and is guided by and movable in the slot. With the guiding mechanism 62, not only can the keycap 3 be guided in a vertical direction, but the displacement of the keycap 3 can also be limited.

In other words, the keycap 3 can be moved to the raised position by virtue of the elastic member 51, and the movement of the keycap 3 can be limited and guided by the limiting mechanism 61 and the guiding mechanism 62.

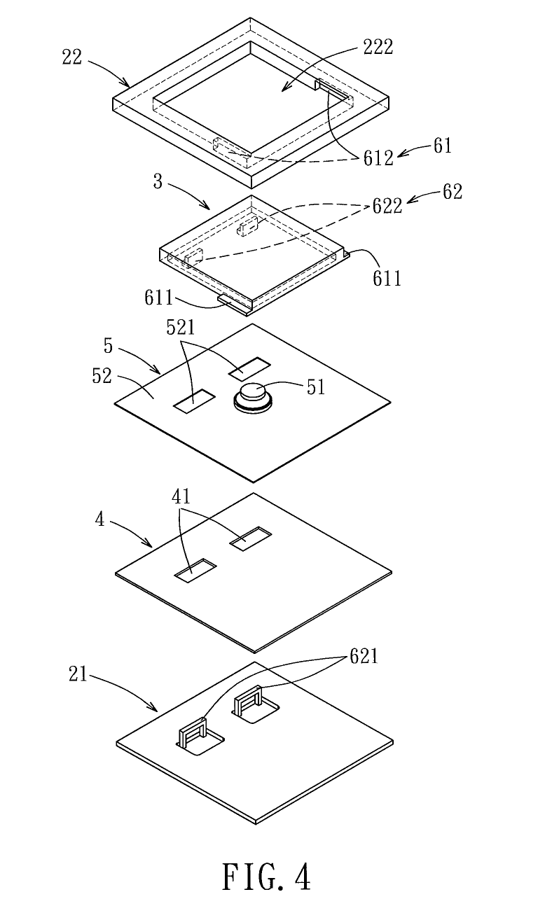

FIG. 4 illustrates the second preferred embodiment of the press key according to present invention. The second preferred embodiment differs from the first preferred embodiment in that the limiting mechanism 61 has two protrusions 611 and two recesses 612. The two protrusions 611 extend respectively from two opposite lateral sides of the keycap 3. The two recesses 612 are respectively formed at two opposite sides of the lower face of the bordering plate 22. With the protrusions 611 formed in two opposite sides of the keycap 3, the upward movement of the keycap 3 can be limited in a symmetrical manner.

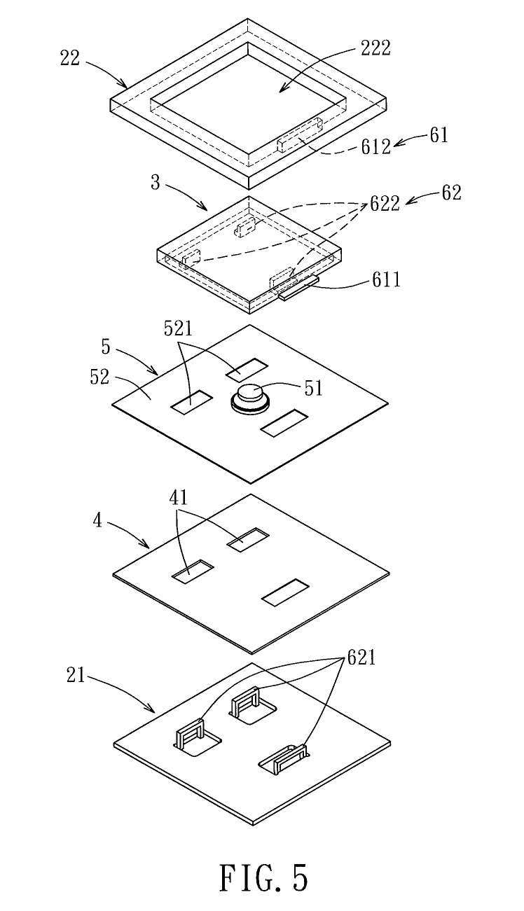

FIG. 5 illustrates the third preferred embodiment of the press key according to the present invention. The third preferred embodiment differs from the first preferred embodiment in that the guiding mechanism 62 includes three guide rails 621 and three guide hooks 622, that the circuit board 4 is formed with three through holes 41, and that the elastic sheet 52 is formed with three through holes 521. In this embodiment, the elements of the guiding mechanism 62 are disposed around the elastic member 51, and thus, the movement of the keycap 3 can be guided by the guiding mechanism 62 in a relatively smooth manner.

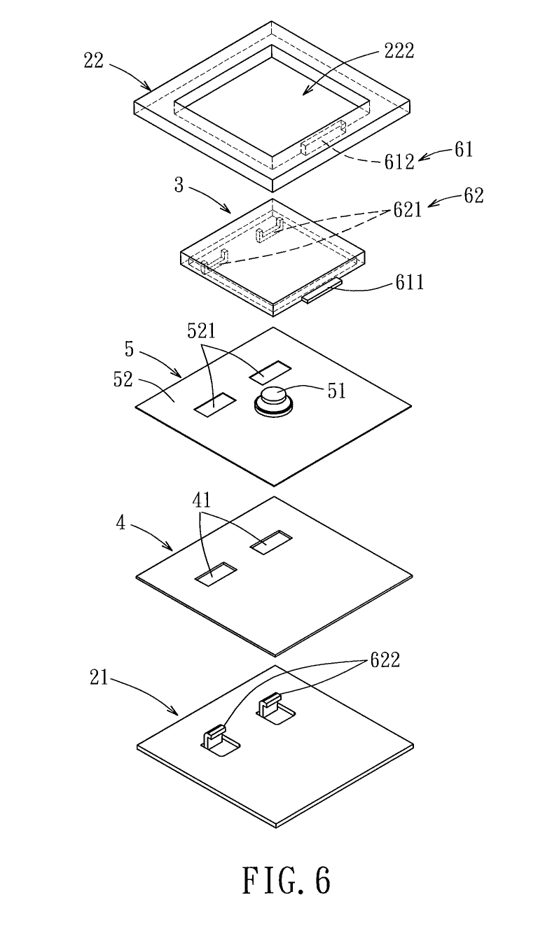

FIG. 6 illustrates the fourth preferred embodiment of the press key according to the present invention. The fourth preferred embodiment differs from the first preferred embodiment in that each of the guide rails 621 extends downwardly from the lower surface of the keycap 3, and that each of the guide hooks 622 extends upwardly from the upper surface of the base plate 21.

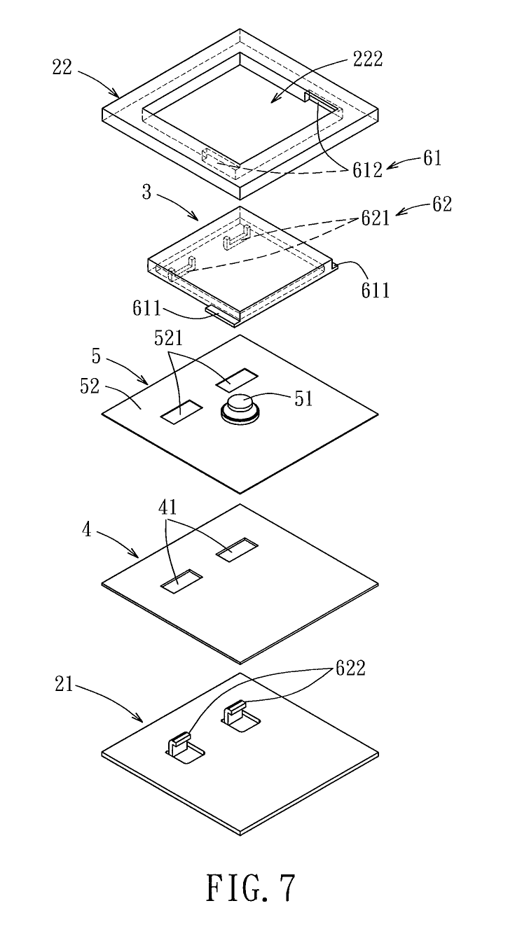

FIG. 7 illustrates the fifth preferred embodiment of the press key according to this invention. The fifth preferred embodiment differs from the second preferred embodiment in that each of the guide rails 621 extends downwardly from the lower surface of the keycap 3, and that each of the guide hooks 622 extends upwardly from the upper surface of the base plate 21.

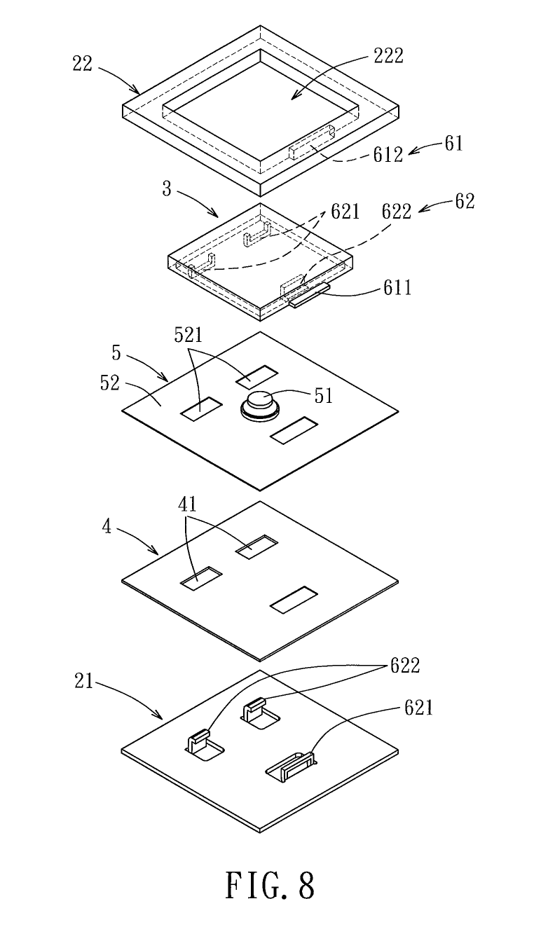

FIG. 8 illustrates the sixth preferred embodiment of the press key according to the present invention. The sixth preferred embodiment differs from the first preferred embodiment in that the guiding mechanism 62 includes three guide rails 621 and three guide hooks 622 disposed at positions corresponding to the guide rails 621, that the circuit board 4 is formed with three through holes 41, and that the elastic sheet 52 is formed with three through holes 521. In this embodiment, two of the guide rails 621 are disposed on the lower surface of the keycap 3, and the remaining one is disposed on the upper surface of the base plate 21. Accordingly, two of the guide hooks 622 are disposed on the upper surface of the base plate 21, and the remaining one is disposed on the lower surface of the keycap 3. The elements of the guiding mechanism 62 are disposed around the elastic member 51, and thus, the movement of the keycap 3 can be guided by the guiding mechanism 62 in a relatively smooth manner.

Since the limiting mechanism 61 and the guiding mechanism 62 have relatively simple structures, the elements of the press key of this invention can be easily assembled. Besides, because the press key of this invention is assembled without the scissors-type supporting structure, the thickness of the press key can be reduced to a minimum.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A press key comprising:
a base plate;
a bordering plate disposed above and coupled to said base plate, and formed with a through hole, said base plate and said bordering plate defining an accommodating space therebetween;
a keycap movable between a raised position and a pressed position, said keycap being configured to pass through said through hole to be partially exposed from said bordering plate when said keycap is at said raised position;
a circuit board disposed between said keycap and said base plate;
an elastic restoring unit disposed between said keycap and said circuit board, and capable of providing a restoring force to move said keycap to said raised position;
a limiting mechanism disposed between said bordering plate and said keycap to prevent an upward movement of said keycap away from said raised position; and
a guiding mechanism disposed between said keycap and said base plate to guide the movement of said keycap.

2. The press key of claim 1, wherein said limiting mechanism includes a protrusion and a recess, said protrusion being disposed on one of said keycap and said bordering plate, said recess being formed in the other one of said keycap and said bordering plate.

3. The press key of claim 2, wherein said protrusion extends from a lateral side of said keycap, said recess being indented from a lower face of said bordering plate in proximity to a wall defining said through hole, said protrusion being disposed in said recess to abut against an inner wall of said recess when said keycap is at said raised position.

4. The press key of claim 1, wherein said guiding mechanism includes a guide rail and a guide hook that is in sliding engagement with said guide rail, said guide rail being disposed on one of a lower surface of said keycap and an upper surface of said base plate, said guide hook being disposed on the other one of said lower surface of said keycap and said upper surface of said base plate.

5. The press key of claim 4, wherein said guide rail is extends upwardly from said upper surface of said base plate to pass through said circuit board, said guide hook extending downwardly from said lower surface of said keycap.

6. The press key of claim 4, wherein said guide rail extends downwardly from said lower surface of said keycap, said guide hook extending upwardly from said upper surface of said base plate.
